(19) United States
(12) Patent Application Publication
(10) Pub. No.: US 2025/0259458 A1
(43) Pub. Date: Aug. 14, 2025

(54) Vehicle Occupant Safety Detection System and Methods of Operating and Training Thereof

(71) Applicants: William LAMEY, Fredericton (CA); Lucas MCCURLIE, Stirling (CA); Jeffrey BEST, Penniac (CA); Vinicius DE ALMEIDA LIMA, St. Stephen (CA); Sheila Esmeralda GONZALEZ REYNA, Fredericton (CA)

(72) Inventors: William LAMEY, Fredericton (CA); Lucas MCCURLIE, Stirling (CA); Jeffrey BEST, Penniac (CA); Vinicius DE ALMEIDA LIMA, St. Stephen (CA); Sheila Esmeralda GONZALEZ REYNA, Fredericton (CA)

(21) Appl. No.: 19/169,262

(22) Filed: Apr. 3, 2025

Related U.S. Application Data
(63) Continuation-in-part of application No. PCT/CA2024/051139, filed on Aug. 30, 2024.
(60) Provisional application No. 63/536,383, filed on Sep. 2, 2023.

(51) Int. Cl. G06V 20/59; B60K 28/00; B60R 22/48; G06V 10/26; G06V 10/82

(52) U.S. Cl. CPC G06V 20/59; B60K 28/00; G06V 10/26; G06V 10/82; B60R 22/48; B60R 2022/4808

(57) ABSTRACT

A system of operating a vehicle occupant safety detection system includes a camera for obtaining an image with a field of all occupants of the vehicle. The image may be processed by a helmet detection sub-system comprising a helmet recognition neural network block containing recognition data for approved helmets, and a helmet monitoring block configured to process the image from the camera to detect the presence of an approved helmet on all vehicle occupants. Additional sub-systems dedicated to detecting other safety devices and their proper use are also provided, for example, an eye protection detection sub-system, and a safety restraint detection sub-system. A binary determination of “safe” or “unsafe” may then be transmitted on a periodic basis to the Vehicle Safety System. In case of an “unsafe” determination, a safety correction action may be taken, such as restricting vehicle speed to a safe limit.

### CROSS-REFERENCE DATA

This patent application claims a priority date benefit from the U.S. Provisional Patent Application No. 63/536,383 filed on Sep. 2, 2023, with the same title, which is incorporated herein by reference in its entirety. This application is also a continuation-in-part of a co-pending international patent application No. PCT/CA2024/051139 entitled “Vehicle Occupant Safety Detection System and Methods of Operating and Training Thereof” filed on Aug. 30, 2024, incorporated here in its entirety by reference.

### BACKGROUND

Without limiting the scope of the invention, its background is described in connection with vehicle safety equipment. More particularly, the invention describes a vehicle occupant safety detection system configured to identify various safety items that the occupants of a vehicle are wearing or using while in the vehicle. More specifically, the invention describes a system configured for using at least one or more video cameras to detect the presence and proper use of an approved safety device such as a helmet, safety belt, or safety harness by all present vehicle occupants.

The utilization of helmets and safety belts in ATVs and UTVs is of paramount importance to mitigate the occurrence of fatalities and injuries. These protective measures are imperative due to the inherent risks associated with off-road riding and uneven terrains, where unexpected collisions, rollovers, and impacts are common. Helmets serve as a crucial safeguard for the head and brain, shielding riders from traumatic injuries. For instance, in the event of a rollover, a helmet prevents head trauma that could result in severe concussions or fatal outcomes. Similarly, safety belts and harnesses play a pivotal role in preventing ejection during abrupt maneuvers or collisions, thereby reducing the likelihood of serious injuries. In a scenario where a UTV suddenly swerves to avoid an obstacle, properly fastened safety belts keep passengers securely in place, averting the risk of being thrown out and sustaining fractures or even fatal injuries. By mandating and enforcing the use of helmets and safety belts in ATVs and UTVs, the potential for catastrophic accidents can be significantly curtailed, fostering a safer environment for riders and minimizing the toll of fatalities and injuries.

Unfortunately, some riders are still avoiding the use of these common-sense safety measures by not wearing a helmet. As to safety belts, systems for detecting their use are simplistic and only monitor the presence of a seat belt tongue in the seat belt buckle. When the seat belt remains unbuckled, the Vehicle Safety System may interfere and restrict the vehicle speed to a safe limit, for example approximately 15 km/h. However, a driver can easily bypass these systems, for example by buckling their seat belt and putting it behind them.

The need exists, therefore, for comprehensive vehicle occupant safety detection systems and methods that are capable of reliable recognition of the presence and proper use of mandated safety devices by all occupants present in a vehicle, all while doing so in the least intrusive manner so as not to reduce the positive rider experience.

### SUMMARY

Accordingly, it is an object of the present invention to overcome these and other drawbacks of the prior art by providing a novel vehicle occupant safety detection system capable of automatic detection of the presence and proper use of at least one safety device by all vehicle occupants.

It is another object of the present invention to provide a novel vehicle occupant safety detection system configured for (i) detecting an “unsafe” condition when at least one vehicle occupant is not properly using the safety device and (ii) transmitting a corresponding notification to the Vehicle Safety System for further action.

It is a further object of the present invention to provide a novel method of automated detection of the proper use of required safety devices by all vehicle occupants.

It is yet a further object of the present invention to provide a novel method of initial determination of proper use of safety devices followed by subsequent determination during the entire period of time when the vehicle is in use.

The vehicle occupant safety detection system of the present invention may be incorporated with or may be operatively connected to a Vehicle Safety System. In embodiments, the system of the invention may include or may have access to at least one camera observing vehicle occupants. The system of the invention may be configured to communicate with the Vehicle Safety System in order to take necessary safety steps if the system of the invention detects an “unsafe” condition for at least one vehicle occupant.

The method of operating a vehicle occupant safety detection system may include the following steps:
a. operating the vehicle occupant safety detection system to automatically obtain at least one image from a camera containing at least one head or one face of a vehicle occupant,
b. operating the vehicle occupant safety detection system to automatically process the at least one image of at least one vehicle occupant using a model database to determine the at least one image as:
   i. “safe” in case the vehicle occupant properly uses all mandatory safety devices, or
   ii. “unsafe” in case the vehicle occupant is present in the vehicle and does not use at least one mandatory safety device, and
c. transmitting a “safe” or “unsafe” notification from step (b) to a Vehicle Safety System, and in case an “unsafe” determination is made, causing the vehicle to operate in a restricted manner.

The vehicle occupant safety system may operate to process the entire image as a whole, or, in other embodiments, may include individual sub-systems. In this case, each sub-system may be configured to detect the presence and proper use by all vehicle occupants of a single safety device specific to that system, such as an approved helmet, an approved eye protection, or an approved safety restraint.

The vehicle occupant safety detection system may include or have access to a camera with a designated field of view to monitor at least one vehicle occupant to facilitate assessment as to whether all mandatory safety devices are present and properly used or not.

In some embodiments, the system may incorporate at least one of the following sub-systems:
(i) a helmet determination sub-system, which consists of a helmet recognition neural network trained on a labeled database of images depicting both correct and incorrect use or absence of an approved helmet, along with a helmet monitoring block that processes camera images to detect the presence of an approved helmet and its proper use;
(ii) an eye protection detection sub-system, comprising an eye protection recognition neural network similarly trained on images of proper and improper use or absence of an approved eye protection, and an eye protection monitoring block that processes camera images to detect the presence and proper use of an approved eye protection device; and
(iii) a safety restraint detection sub-system, which includes a safety restraint recognition neural network trained to recognize correct and incorrect use or absence of an approved safety restraint, along with a monitoring block that processes images to detect the presence of a required safety restraint device and its proper use by all vehicle occupants.

In other embodiments, the vehicle occupant safety detection system may process at least one or multiple images of vehicle occupants to simultaneously detect the presence and proper use of more than one safety device by all vehicle occupants, as the invention is not limited in this regard.

The system may be designed to automatically analyze the images of vehicle occupants to define vehicle operation as “safe” if all mandatory safety devices are correctly used by all present vehicle occupants or as “unsafe” if at least one required safety device is absent or improperly used by at least one occupant present in the vehicle.

### BRIEF DESCRIPTION OF THE DRAWINGS

Subject matter is particularly pointed out and distinctly claimed in the concluding portion of the specification. The foregoing and other features of the present disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1 is a general block diagram of the vehicle occupant safety detection system,

FIG. 2 is a general block diagram of the system configured to collect and label images of vehicle occupants to create a training database of labeled images depicting one or more vehicle occupants and the use or lack of use of one or more safety devices,

FIG. 3 is a block diagram showing more details of the data collection part of the system in FIG. 2.

FIG. 4 is a block diagram showing more details of the system to process images collected from the video recordings,

FIG. 5 is an example of an image frame depicting two vehicle occupants,

FIG. 6 is a block diagram of the steps needed to create the occupant image database for computer model training purposes,

FIG. 7 is a block diagram of the image labeling portion of the system of FIG. 2,

FIG. 8 is a block diagram of the optional image augmentation portion of the system in FIG. 1 or FIG. 2,

FIG. 9 is a block diagram of the computer training using neural networks and creating of a computer model ready for deployment onto vehicles,

FIG. 10 is a block diagram of one embodiment of the vehicle occupant safety detection system,

FIG. 11 is a depiction of one type of approved helmet,

FIG. 12 is a depiction of another type of approved helmet,

FIG. 13 is a depiction of yet another type of approved helmet,

FIG. 14 is an example of a helmet covering the face of the vehicle occupant,

FIG. 15 is an example of a helmet not fully covering the face of the vehicle occupant,

FIG. 16 is an example of assigning a bounding box to a head of the vehicle occupant,

FIG. 17 is a block diagram of another embodiment of the vehicle occupant safety detection system,

FIG. 18 is an example of processing an image depicting all vehicle occupants by the system shown in FIG. 17, and

FIG. 19 is an example of a “safe” or “unsafe” determination by the system shown in FIG. 17.

### DETAILED DESCRIPTION OF PREFERRED EMBODIMENTS OF THE INVENTION

The following description sets forth various examples along with specific details to provide a thorough understanding of the claimed subject matter. It will be understood by those skilled in the art, however, that claimed subject matter may be practiced without one or more of the specific details disclosed herein. Further, in some circumstances, well-known methods, procedures, systems, components and/or circuits have not been described in detail in order to avoid unnecessarily obscuring claimed subject matter. In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and make part of this disclosure.

While the present invention can be used with a wide variety of vehicles, such as cars, bicycles, motorcycles, trucks, boats, jet skis, etc., it is described herein with an exemplary emphasis on off-road vehicles. In particular, the invention may find advantageous use in power sports, such as snowmobiles, personal watercraft vehicles (PWC), All-Terrain Vehicles (ATV), and Utility Terrain Vehicles (UTV), including multipurpose Side x Side (SXS) utility terrain vehicles, and Side x Side (SXS) sport vehicles.

Novel systems and methods of the present invention effectively address the need described above by determining if drivers and passengers are wearing all mandatory safety devices such as helmets, goggles, and safety belts correctly.

The system utilizes artificial intelligence (AI) based on a machine learning method of processing an image from at least one suitably positioned camera. The camera or a system of cameras may be built into the vehicle itself, in which case the vehicle occupant safety detection system of the invention may be configured to communicate with the vehicle's safety system or other vehicle's systems to have access to at least one, several, or all cameras available in the vehicle. Alternatively, at least one or more dedicated vehicle cameras may be provided as part of the system of the present invention so as to enable the observation of the vehicle occupants and the determination of safety as described below.

In further embodiments, the system of the invention may be configured to utilize both the vehicle's cameras as well as additional dedicated cameras, for example, for observing passengers in the back of the vehicle, as the invention is not limited in this regard. At least one or more cameras may be located throughout the interior of the vehicle, for example, on the dashboard of the vehicle, at an elevated position on a rear-view mirror, or in other suitable locations. An elevated camera may be advantageous as it can also observe backseat occupants, if any. At least one or more cameras may be positioned in the vehicle to have a field of view directed to detect the presence and proper use of safety devices by all occupants of the vehicle, such as from various viewpoints so as to provide a comprehensive assessment of the use of one or more safety systems by everyone in the vehicle.

Other sensors can be used to capture the input data to train the detection models, for example, a Lidar, an infrared sensor, or a Radar which may produce a 3D scan of the interior of the vehicle. In further embodiments, a combination of any of these or other imaging sensors may be used, as the invention is not limited in this regard. Suitable AI models may be trained on this 3D data to detect occupants with helmets. For the purposes of the present invention, these alternative sensors are also included in the definition of the term “camera”. Furthermore, the term “camera” may further include a receiver for dedicated radio transmission or detection of a dedicated proximity tag known to be associated with certain helmets that may be equipped with such tags and transmitters.

Through extensive machine-learning training as described below, the computer model for use with a neural network may be developed that may recognize different approved helmet types and other safety equipment and accurately assess if they are worn correctly and securely. The camera or a system of cameras may provide a clear view of both the driver and passengers, enabling the computer model of the system of the invention to make precise judgments. In cases where a person is detected to be without a helmet, for example, the system of the invention may be configured to generate a warning message. In embodiments, the system of the invention may, for example, notify the vehicle's safety system operating the vehicle's user interface to remind the occupants of the need to wear safety devices.

In other embodiments, if an “unsafe” determination is made, the system of the invention may be configured to notify the Vehicle Safety System so that appropriate safety steps may be taken to restrict the operation of the vehicle. One example of such a safety step is a reduction in the vehicle's speed to a safe level, for example, 15 km/h, or another mandatory safety limit. This restriction may be maintained until all occupants take corrective action by properly wearing the necessary safety devices. Once the system of the invention has determined that the occupant's conditions change to “safe”, the Vehicle Safety System may be notified that the vehicle operation restriction may be lifted.

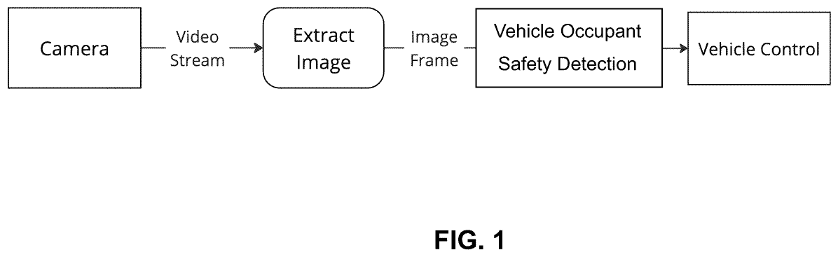

In broad terms (see FIG. 1), the system of the invention may include a camera to provide a video stream to an image extraction module. The image extraction module may be operated to take one or several images from the video stream and pre-process these images to produce and feed suitable image frames to the vehicle occupant safety detection module. This module, in turn, is designed to use neural networks or other AI-based image processing techniques to determine is all present vehicle occupants are properly wearing all mandated safety devices. Based on this determination, the system of the invention makes a “safe” or an “unsafe” determination as described below in greater detail and communicates that determination to the vehicle control portion of the vehicle which may be configured to restrict the operation of the vehicle in one or more suitable ways or allow the vehicle to be operated in an unrestricted manner.

Machine learning and the use of neural networks are at the core of the operation of the system of the invention. To enable local vehicle-based processing of occupant images so as to determine the presence and proper use of all required safety devices, the vehicle-based system may be provided with a computer model containing information that may be used by the vehicle-based processor to interpret the images fed by the at least one camera and make that safe/unsafe determination. The present invention does not rely on any remote server for processing the images of the vehicle occupant and making the safe/unsafe determination, as all required components and the computer model for such determination are present in the vehicle equipped with the system of the invention.

### Computer Model for Detection of the Presence and Proper use of Approved Safety Devices

The core of the system is based on creating and training a computer model to recognize the presence and proper use of one or more approved individual safety systems. The computer model may include one or more safety devices in a single model. In other embodiments, each individual safety device, such as a helmet, a safety belt or harness, or eye protection, may be covered by a corresponding individual computer component of the model, with each component pre-trained on a plurality of approved safety devices of each type. Computer model training is generally based on the principles of Machine Learning techniques, and more specifically, may be based on using a Convolutional Neural Network (CNN) or other suitable variations of a Deep Neural Network.

Computer model creation and training as a whole or individual training of model components is done prior to installation and use of the computer mode of the present invention on a vehicle. In addition to initial training, the computer model of the invention may be updated or upgraded after initial installation, for example, by uploading improved computer models or components of the computer model that may be separately created and trained by the manufacturer or another third party.

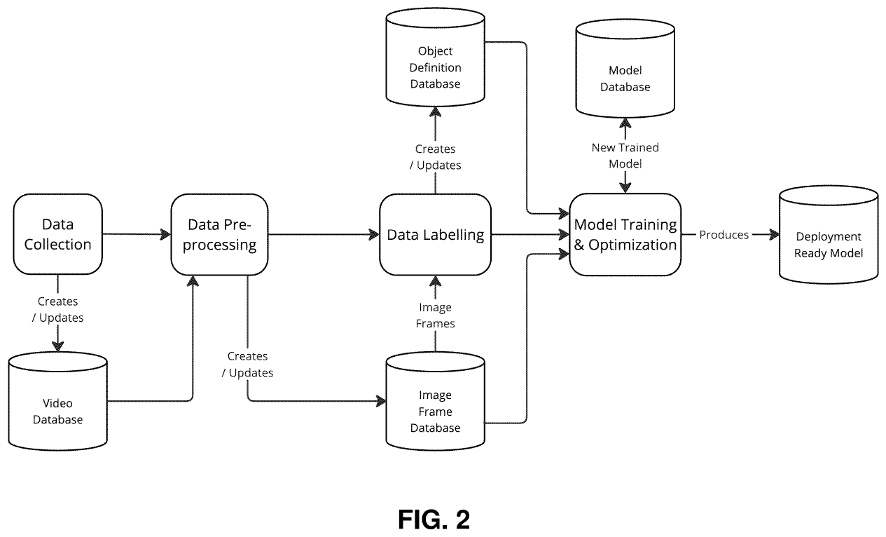

Image processing steps needed for training a computer model prior to installation into the system of the invention are now described in greater detail. FIG. 2 shows a general block diagram of the elements and data flow within the system used to collect a plurality of data images showing correct (proper) and incorrect use of safety devices or lack thereof to train the system of the invention on recognizing and confirming the proper use of the Vehicle Safety System. In broad terms, the system may be operated to collect the data in the form of an image or a series of images, followed by steps of data preprocessing, data labeling, model training, and optimization, and supplying the result to the model database. These elements and steps are described in greater detail below.

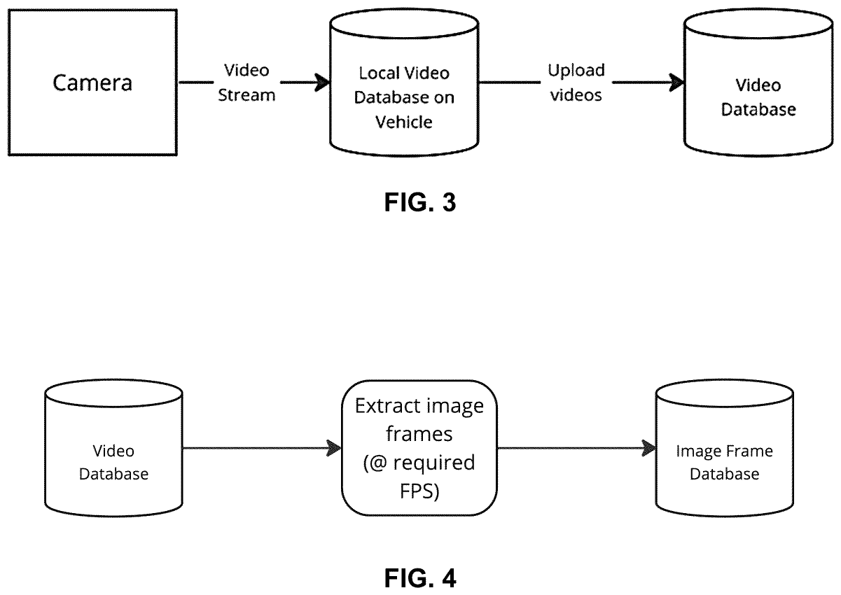

The data collection block of FIG. 2 used for model training purposes is illustrated in greater detail in FIG. 3 and further illustrated in FIG. 4. Image data may be collected from the data collection platform (e.g. a vehicle with a camera and a data logging device) in the form of a camera video stream with relevant input data (e.g. occupants with the right and wrong equipment on). Data may be stored locally in a local video database on the vehicle itself (see FIG. 3). Alternatively or in addition, collected data can be uploaded into a centralized storage in the video database (e.g. network storage, or cloud storage) that may be configured for that purpose.

Optional image data preprocessing shown schematically in FIG. 4 may include processing the video streams collected in the previous block to decompose them into still images at a predetermined frame rate (e.g. 1-20 FPS). These still image frames may then be temporarily stored separately from and in addition to the original source video streams, for example using an image frame database.

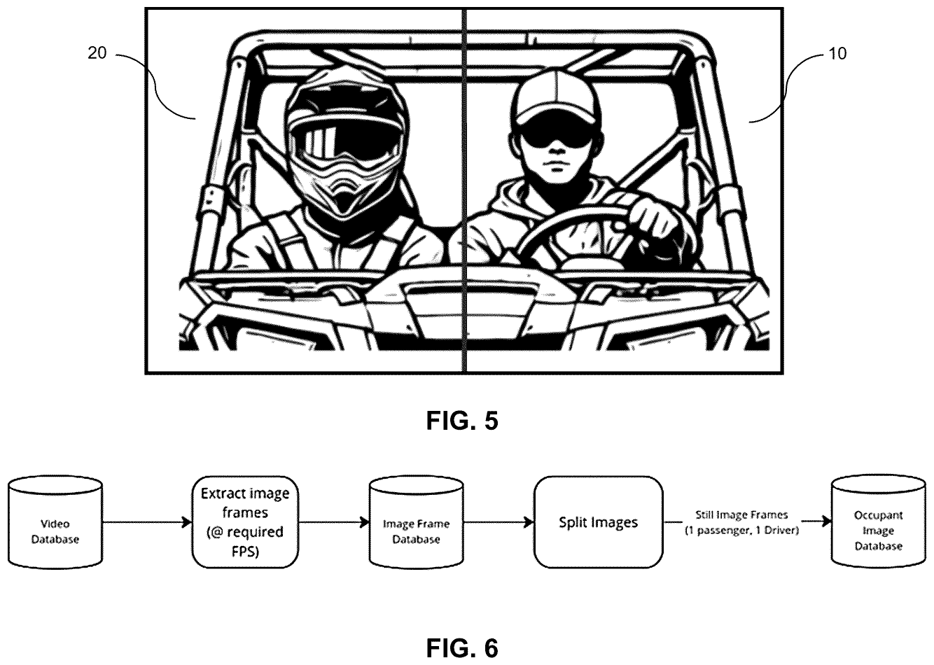

In some embodiments, at least some or all still images may then be subdivided to create separate images-each depicting one occupant of the vehicle. For example, for a two-seater vehicle, the image may be divided into a left portion 10 and a right portion 20, as seen in FIG. 5. These optional steps may be useful for individual training of components of the model.

If more than two occupants may be present, such as in a vehicle with more than one row of seats, or if more than one camera is used, individual still images from all cameras may be suitably divided to identify a single person in each image. These images may then be stored separately and become a part of the “Occupant Image Database.” The original still images with multiple occupants in each image may then be discarded as no longer useful. If needed, these earlier images may be re-generated, for example, if the system experiences a loss of data or an unexpected shutdown. These steps are further illustrated in a diagram in FIG. 6.

In other embodiments, where the computer model is trained on the entire image of all vehicle occupants using one or more safety devices, at least some or all still images may be processed as a whole to identify the presence of all vehicle occupants, as the invention is not limited in this regard.

In further embodiments of the training system as well as the operational implementation of the system of the present invention, the system may be configured to track each detected occupant periodically, from time to time, or continuously—once the system is started or once the occupant first appears in the field of view of at least one camera of the system. This may be advantageous if the occupant is not seen fully by the camera on a consistent basis. The determination as to the proper use of the safety devices may be made when a sufficient portion of the head and upper shoulders of the occupant is seen by the camera, such as at least half of that full image). Key measurements or fiducial points may be determined using the first sufficiently full image of the occupant. After that, even though the occupant may not be fully seen by the camera, a “safe” or “unsafe” determination may still be maintained if the visible portion of the occupant's image does not differ from the same portion of the occupant's image which was used to determine the “safe” or “unsafe” condition previously.

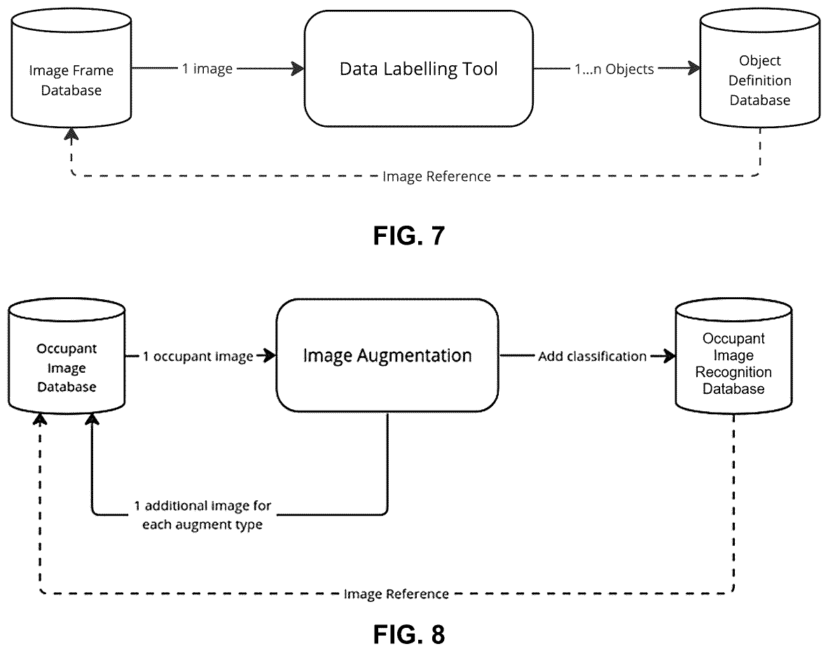

The next step in the process of model training is “data labeling,” illustrated in greater detail in FIG. 7. Each image from the Image Frame Database or from the Occupant Image Database if available, may be fed through a custom tool. This allows a human observer or a suitable AI-enhanced image recognition tool to view one image at a time, and mark or label the presence/absence and correct/incorrect use of all safety devices on all vehicle occupants. This may be done using a Data Labelling Tool—as seen in FIG. 7. In other embodiments, the labeling process may cover only one specific safety device (e.g. Helmet Detection, Eye Protection Detection, Seat Belt Detection, etc.), which corresponds to the component of the computer model that will be trained on the labeled images. Following the step of data labeling, a new Occupant Image Recognition Database may then be created (or the existing database may be updated) with the labeling results. The unique recognition labeled record for each image may be created to be stored with a reference to the source image that was used from the Image Frame Database. In that case, labeled frames can be correlated later in the training process to the original source data. In addition, the recognition and labeling results can be reviewed in the Data Labelling Tool.

Optional image augmentation steps are illustrated further in FIG. 8. In order to increase the variety of images to be used as a source input to the computer model training, image augmentation techniques may be used to create “new” or “additional” versions of existing images. Several common image manipulation techniques (here referred to as augmentations) may be implemented for that purpose (e.g. cropping, rotation, mirroring, blurring) to generate these additional images. These additional images reduce the need to gather additional “real” source data to improve the variety of the input image data set, creating a more balanced data set, which ultimately creates a more robust computer model.

Furthermore, for each original image in the Image Frame Database or the Occupant Image Database, at least one new image may be created for each augmentation technique and may be added as a new image back to the original image database. These new augmented images may be assigned the same recognition label as the original source image and then added as new entries in the Occupant Image Recognition Database or the Occupant Image Database.

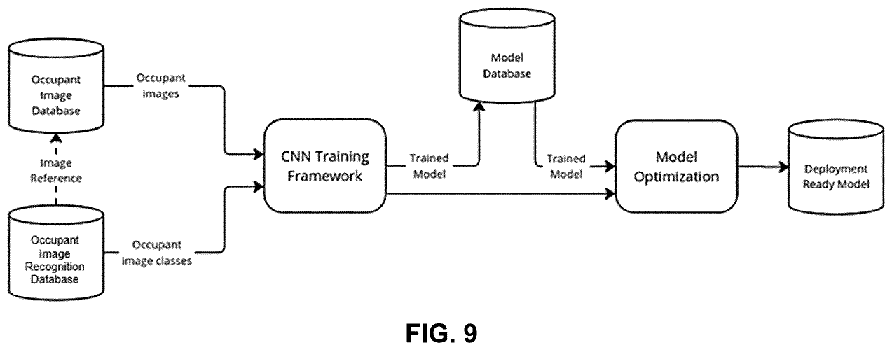

Finally, computer model training is seen in greater detail in FIG. 9. The previously labeled dataset (the combination of the Image Frame Database, Occupant Image Database and the corresponding Occupant Image Recognition Database, where available) may then be used to train a Convolutional Neural Network (CNN) in the Model Training and Optimization Module, as generally seen in FIGS. 2 and seen in FIG. 9 with more details.

The CNN model, which may consist of multiple layers such as convolutional, activation, pooling, and fully connected layers, is initialized with random or pre-trained weights. During training, the labeled images are passed through the network, where convolutional layers extract hierarchical features, pooling layers reduce dimensionality, and fully connected layers interpret these features to make predictions. The output is compared against the true labels, for example, using a loss function, such as categorical cross-entropy for classification tasks. The backpropagation algorithm, coupled with an optimizer like stochastic gradient descent (SGD) or Adam, may be used to adjust the model's weights iteratively to minimize the loss. This process continues for multiple epochs, during which the model progressively learns more accurate feature representations. To prevent overfitting, techniques such as dropout, batch normalization, and validation data monitoring may be employed. Once training is complete, the computer model or individual components thereof may be evaluated on a separate test set to assess its generalization performance. If necessary, hyperparameter tuning and further adjustments may be made to optimize accuracy.

In embodiments, the trained computer model may be further run through one or more model optimization techniques (e.g. balancing, operating simplification, data type simplifications, etc.) to improve the performance of the model for the target vehicle hardware. This final Deployment Ready Model can then be deployed in the vehicle system.

### Description of a Vehicle Occupant Safety Detection System Operated by Individual Sub-Systems

The vehicle occupant safety detection system may include one or several independent monitoring sub-systems that may be operated using individual components of the computer model dedicated to a specific type of safety device. If more than one sub- system is present, they may be operated to run in parallel, as illustrated in FIG. 1. The image received from the camera, in this case, may be split into portions, each depicting a single vehicle occupant, and then individually fed into one or more sub-systems, for example, a helmet detection sub-system, an eye protection sub-system, and a safety restraint detection sub-system. Each sub-system may be configured to track and assess one specific corresponding safety device type for all occupants present in the vehicle.

The helmet detection sub-system may include a helmet recognition neural network block containing recognition data and a helmet recognition component of the computer model configured to check for the presence and proper use of approved helmets, and a helmet monitoring block configured to process the image from the camera to detect the presence of a helmet, if any, and a determination if the helmet is an approved helmet and if it is used properly.

The eye protection detection sub-system may include an eye protection neural network block containing recognition data and an eye protection recognition component of the system configured for detecting the presence and proper use of approved eye protection safety devices. It further includes an eye protection monitor block configured to process the image from the camera for detecting whether the vehicle occupants are properly using required eye protection devices.

Furthermore, a sub-system for detecting the proper use of a safety restraint may also be provided. Such a sub-system may include a dedicated safety restraint neural network block with recognition data on approved safety restraint devices and a restraint device component of the computer model configured to detect the presence and proper use of a required safety device. It may further include a monitoring block configured to process the image from the camera to detect whether vehicle occupants are using approved and required safety restraint devices.

Every sub-system may be configured to produce a binary determination for the specific safety device that it is monitoring, such as “safe” or “unsafe.” The outputs of these asynchronously run sub-systems may be fed into a single Vehicle Control Interface module that combines the individual monitor outputs into a single vehicle control message.

Once a single determination is made using individual determinations from corresponding sub-systems, it may then be fed into the Vehicle Safety System, which may be a part of the vehicle control system. The Vehicle Safety System may be configured, in case a “safe” determination is made by all operating sub-systems, to allow full operation of the vehicle by the driver. If at least one of the sub-systems of the vehicle occupant safety detection system of the invention reports an “unsafe” determination, the Vehicle Safety System may be configured to limit vehicle operation to a restricted state.

Vehicle restrictions may take various forms, such as limiting maximum speed, as described above, preventing the vehicle from moving, etc. In addition, a warning signal to the driver may be visually displayed or audibly produced to alert the driver to the state of restricted operation of the vehicle.

### Helmet Detection

The following part of this disclosure describes in more detail the operation of one exemplary sub-system, namely the helmet detection sub-system of the present invention. The term “helmet” is used herein to describe any head protection device that may be worn on the head of the user and can be visually discerned by its shape using a video or another type of camera. For safety regulation purposes, the driver and passenger shall wear a DOT—or another appropriate government entity-approved helmet. Satisfying a safety standard may include compliance with regulations from DOT, the United Nations Economic Commission on Europe (ECE), or other safety standards.

Exemplary helmets are shown in FIGS. 11-13. Approved helmet types may include:
a. “Half Helmet” that covers only the top portion of the head, but the face is exposed, see FIG. 11;
b. “Full faced helmet”—an off-road/on-road style helmet that covers the entire head, including a shield covering the eyes and nose, see FIG. 12;
c. “MX helmet”-an off-road style motocross helmet that covers the full head, but does not cover the eyes/nose, see FIG. 13.

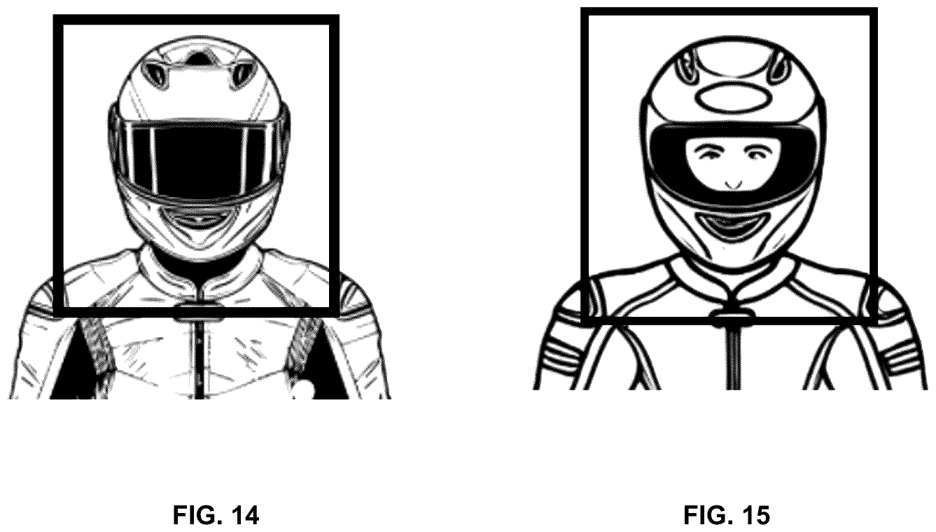

The helmet may cover some or all of the face of the user with transparent or non-transparent materials. In some cases, the helmet can cover the entire face and the head of the user, as seen in FIG. 14. In other cases, only the head of the user is covered with the face fully visible, as seen in FIG. 15.

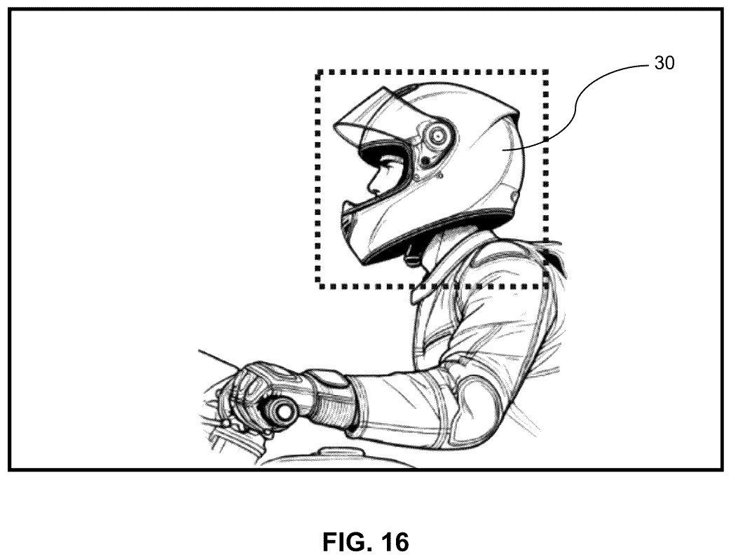

The helmet detection sub-system of the invention may be pre-trained to recognize all types of approved helmets. In fact, as seen in FIG. 16, when the face is visible within the bounding box 30 around the helmet, the helmet detection sub-system of the invention may be further configured to identify the user using face recognition techniques. In an alternative approach to the invention, this sub-system can identify the driver and treat the driver differently from the vehicle's passengers, in case safety regulations are different for the driver as compared to passengers.

When the face is not fully seen, such as the case when the user is wearing goggles, the bounding box and the helmet detection may be conducted in either one of the following two ways:
a. by detecting the upper body of the user along with the helmet (both the upper body and the helmet may be included in the bounding box), or
b. by performing a body shoulder regression and helmet detection by using anatomically appropriate detection of shoulder joints as anchoring points and detecting the helmet at a location above the shoulders, followed by a check to confirm that they are in an anatomically acceptable relationship with each other, such as certain distance/angle relations.

Various other Object Detection techniques may also be used for this purpose.

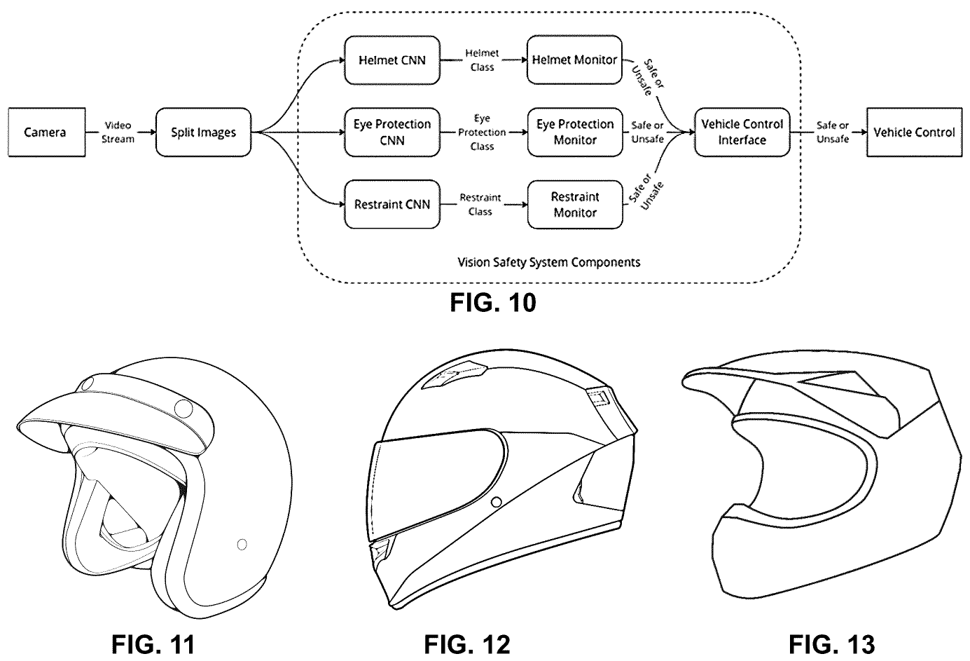

A method of operating a helmet detection sub-system of the safety detection system of the present invention, as described above and illustrated in FIG. 10, may include the following steps:
a. operating the vehicle occupant safety detection system to obtain at least one image from the camera containing at least one head or one face of a vehicle occupant.

The time intervals between the images may range from minutes down to fractions of a second, for example, every 10 min, every 5 min, every 1 minute, every 30 sec, every 1 sec, twice a sec, 10 times a sec, 50 times a sec or more, as the invention is not limited in this regard. In one example, image collection may occur in the range of 5 to 20 frames per second (FPS). Obtained still images may be optionally enhanced using conventional image enhancement techniques, such as improving sharpness, focus, removing artifacts, etc.
b. operating the vehicle occupant safety detection system to process the at least one image of at least one vehicle occupant using a computer model pretrained using a labeled database of images showing proper use and improper use/lack of use of an approved helmet to define the at least one image as “safe” in case the vehicle occupant properly uses all mandatory safety devices or as “unsafe” in case the vehicle occupant is present in the vehicle and does not use at least one mandatory safety device.

Using image processing techniques, the system of the invention may be automatically operated to identify one or more heads or faces of vehicle occupants in the image obtained from the camera in step (a).

This step may be followed by a step of dividing each image to form two or more sub-images pertaining to a full or partial capture of a head or a face of individual vehicle occupants. If the vehicle is a two-seater, for example, a single vertical line may be used in the middle of the image to form a left portion and a right portion of the image so as to capture the driver and passenger spaces separately.

For vehicles having a front seat and a rear seat, the system of the invention may include additional cameras or be configured to have a single camera with sufficient field of view to observe all passengers and occupants of the vehicle. In that case, the single image from this camera may be divided into more than two portions so as to form individual sub-images, each pertaining to a single vehicle occupant.

The system of the invention may then be operated to automatically analyze each individual sub-image containing a single head of an occupant using a computer model described above to detect an approved helmet in use by that occupant.

The system of the invention may be pre-trained to detect approved helmets on occupants, as seen in FIGS. 11 through 13. The computer model or a component thereof may use a pre-trained Convolutional Neural Network (CNN) to categorize at least some or each occupant's image into one of the following four categories:
(i) No occupant (there is no occupant detected, while the system of the invention is trained to recognize human shape from head/torso),
(ii) An occupant is present and is wearing a non-approved headwear (e.g. hat, cap, bike helmet, skiing helmet, or another helmet that is not impact-rated for road usage,
(iii) An occupant is present but wears no helmet (occupant does not have anything covering their head),
(iv) An occupant is present and wears an approved helmet.

Following the completion of step (b), the helmet detection sub-system may then perform step (c) of automatically transmitting a notification to the Vehicle Safety System. In embodiments, such notification may be always expected and may be either “safe” or “unsafe”. In other embodiments, a notification may only be generated in case an “unsafe” determination is made in step (b) and a corrective safety action needs to be taken.

In further embodiments, generating and transmitting a message to the Vehicle's Safety System may be done in one of the following situations:
a. In case the driver's helmet is NOT detected to be present, an output message may then be sent:
   i. to the Vehicle Safety System to limit the speed or otherwise restrict the operation of the vehicle,
   ii. to the user interface to notify the driver that one or more occupants are not wearing an approved helmet,
b. In case an approved helmet properly worn by the occupant has NOT been detected for a predetermined amount of time, AND there is an occupant detected to be present, an output may then be sent:
   i. to the Vehicle Safety System to limit the speed or otherwise restrict the operation of the vehicle,
   ii. to the user interface to notify the driver that one or more occupants are not wearing an approved helmet,
c. In case an approved helmet is properly worn by any occupant as it has been detected by the system AND there is an occupant, an output may then be sent:
   i. To the Vehicle Safety System to NOT restrict the use of the vehicle,
   ii. To the user interface (e.g. vehicle screen) to notify the driver that all occupants are wearing approved helmets.

### Eye Protection Detection

In addition to a sub-system detecting the presence and proper use of the helmet by all occupants of a vehicle, additional sub-systems may be present and configured to detect the presence of eye protection, the use of a safety belt or harness, as well as other required or optional safety measures. For example, as required by the American National Standard for Recreational Off-Highway Vehicles (ANSI/ROHVA 1-2023), occupants of recreational off-highway vehicles must wear eye protection. These vehicles often do not have windscreens or windshields.

The eye-protection detection sub-system may operate in a similar manner to the helmet detection, as now described in greater detail. The first step may be the same as described above for the helmet detection sub-system. Step (b) may include operating the computer system to automatically analyze each individual image containing a single head of an occupant using a computer model component described above to detect an approved eyewear in use by that occupant.

Each sub-image may be analyzed by a computer model pre-trained to detect the use or lack thereof of an approved eye protection safety device by one or more vehicle occupants. The computer model may also use a pre-trained Convolutional Neural Network (CNN) or another Deep Neural Network (DNN) to classify at least some or each occupant image into one of the following categories:
a. No occupant (there is no occupant detected, while the model is trained to recognize human shape from head/torso),
b. An occupant is present and wears approved eye protection. Approved eye protection may include:
   i. Safety glasses rated for impact,
   ii. A helmet with a full visor, and the visor is down over the eyes,
   iii. An MX helmet with goggles worn over the eyes;
c. An occupant is present but has non-approved eye protection,
d. An occupant is present but wears no eye protection.

The remaining steps and notifications of the method may be the same or similar to what is described above for the helmet detection sub-system.

### Safety Restraint Detection

A further sub-system may be provided and configured to detect the proper use of a safety restraint (such as a seat belt or a harness) by all vehicle occupants. The first step of the operating method may be the same as described above. Step (b) may include operating the system of the invention to automatically analyze each individual image containing a single head of an occupant using a computer model described above to detect the proper use of an approved safety restraint by that occupant.

Each sub-image may be analyzed by a computer model pre-trained to detect approved safety restraints on occupants. The computer model may also use a pre-trained Convolutional Neural Network (CNN) or another Deep Neural Network (DNN) to classify at least some or each occupant image into one of the following categories:
a. No occupant (there is no occupant detected, while the model is trained to recognize human shape from head/torso),
b. An occupant is present and has an approved safety restraint,
c. An occupant is present but has no safety restraint present.

The remaining steps may be also similar to those described above.

### Description of a Vehicle Occupant Safety Detection System Operated by a Single Computer Model

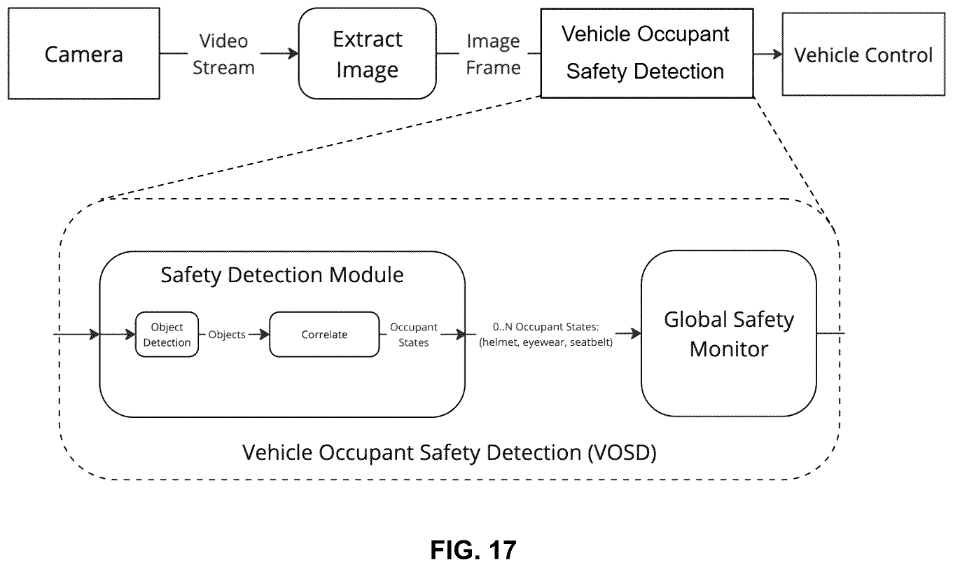

FIG. 17 shows the details of another embodiment of the system in which the Vehicle Occupation Safety Detection is done all in one computer model and by a single module, configured to process the entire image or a series of images depicting one or more vehicle occupants and assessing whether all of the occupants are equipped with all applicable and mandated safety devices. At the core of this embodiment of the present invention is a single Safety Detection Module configured to use a pre-trained computer model to analyze all occupants and determine if they use proper safety equipment. The Vehicle Occupant Safety Detection system is designed to ensure that all occupants within a vehicle adhere to safety regulations by detecting the presence of individuals and verifying their use of mandatory safety devices such as helmets, eye protection, and seatbelts/harnesses. The system operates in real-time, utilizing a camera feed and computer vision techniques to assess the safety status of each occupant before determining whether the vehicle can be placed in a Safe Operating Mode or an Unsafe Operating Mode.

A live video feed from the camera is periodically (such as at predefined intervals) or continuously processed to extract individual image frames for further analysis. These extracted frames are then forwarded to the Safety Detection Module for object detection and safety assessment using CNN and the pre-trained computer model. This module is responsible for identifying occupants and detecting their use of safety equipment. The process includes the following elements:
Object Detection: Computer vision algorithms detect all vehicle occupants in the image frame. Safety devices such as helmets, eyewear, and seatbelts are also identified.
Correlation: Detected safety devices are correlated with the appropriate occupants.

Each occupant is assigned an occupant state, which specifies whether they are using the required safety equipment.
Occupant State Output: The module outputs a set of occupant states, where each state describes the safety compliance of an individual occupant.

The system also features a Global Safety Monitor which takes input from the Safety Detection Module, aggregating all occupant states into a unified decision. The system then evaluates whether all detected occupants meet the required safety criteria. If all occupants meet the safety requirements, a “safe” signal is generated. If any occupant fails to comply, an “unsafe” signal is issued.

As in the previous embodiments, the system of the invention may be operatively connected to the Vehicle Control System or Vehicle Safety System. The “safe” or “unsafe” signal is transmitted to the Vehicle's Control System. Based on this signal, the vehicle may:
Allow normal operation if all occupants comply with safety requirements; or
Restrict vehicle functions (e.g., limiting speed, preventing ignition, or displaying safety warnings) if any occupant does not meet the criteria.

Operational Conditions may be imposed by the system of the invention. If the system detects multiple occupants (e.g., a driver and passenger), all individuals must meet safety criteria for the vehicle to operate normally. If at least one occupant is non-compliant, the Global Safety Monitor prevents the vehicle from entering the Safe Operating Mode.

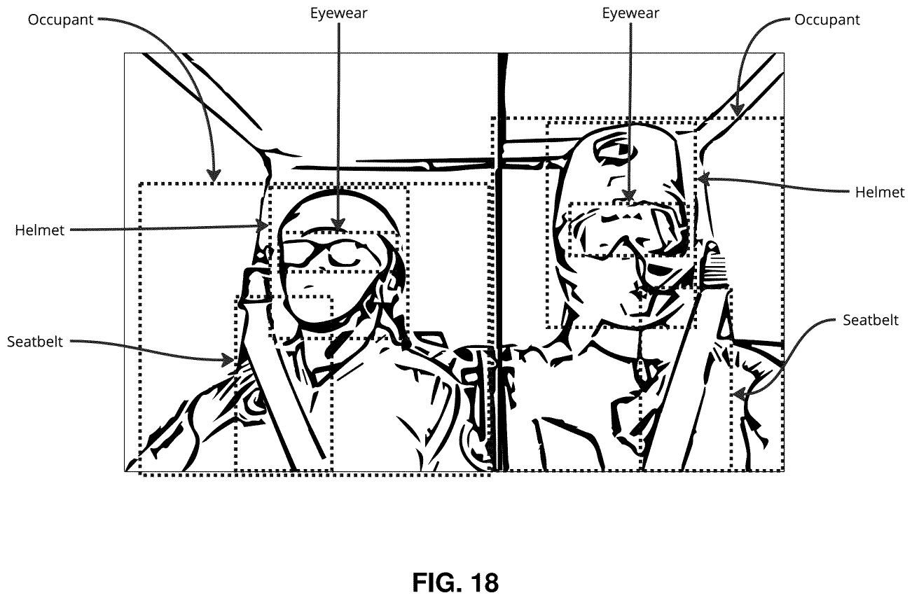

FIG. 18 shows an example of the multiple processing of the single image frame, in which the system of the present invention is configured to identify two occupants and discern appropriate areas to detect all safety devices pertaining to each occupant (shown in respective dotted line rectangles).

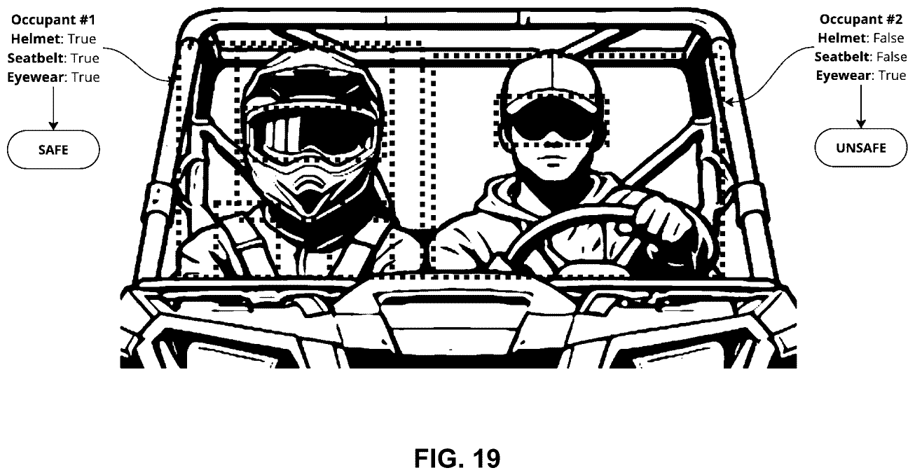

FIG. 19 shows an example of the output of the assessment of all vehicle occupants: while the passenger on the left of the image is determined as complying with all safety regulations, the driver is determined as non-complying by recognizing that the safety belt is not used properly. Therefore, the overall conclusion is that the vehicle cannot be operated normally and requires a restricted mode of operation.

Video monitoring of the occupants will continue. Once the system identifies that the driver is properly using the safety belt, the system will automatically lift the restriction on the operation of the vehicle.

The following is a broad discussion of various advantages of the present invention as compared to other systems of the prior art that are designed for automated detection of vehicle occupants using a variety of safety devices.

The main advantage of this invention is its novel use of a pre-trained neural network based on deep machine learning, which enables the system to directly predict whether a rider or passenger is correctly wearing a helmet or other mandatory safety devices. Unlike traditional methods that rely on internal databases for comparison, this system eliminates the need for storing and retrieving reference images, allowing for faster and more efficient real-time safety assessment. By leveraging deep learning, the system continuously improves its accuracy over time and adapts to variations in helmet types, safety gear designs, and environmental conditions.

Another major benefit is the system's versatility in monitoring different types of vehicles. It is designed to function seamlessly on “saddle” vehicles such as motorcycles and all-terrain vehicles (ATVs), as well as on four-wheeled off-road and utility vehicles like side- by-sides (SxS) and utility task vehicles (UTVs). Beyond recreational and utility vehicles, the technology can also be extended to passenger vehicles used in specialized industries, such as construction and mining, where the proper use of safety equipment is mandated. This adaptability makes it a valuable safety solution across multiple sectors.

Additionally, the system is not limited to monitoring just the driver but extends its detection capabilities to all occupants within the vehicle. This comprehensive monitoring ensures that every individual, including passengers, is in compliance with applicable safety regulations. By providing a holistic view of occupant safety, the system enhances overall protection and reduces risks associated with improper or absent safety gear, making it particularly beneficial for industries and applications where strict safety adherence is required.

Furthermore, this invention provides a comprehensive, integrated safety monitoring system that simultaneously assesses multiple critical safety aspects, including helmet usage, seat belt compliance, and protective eyewear adherence. Unlike systems that focus on a single safety feature, this solution ensures that all required safety measures are in place before the vehicle is permitted to operate at full power or speed. This preemptive enforcement mechanism enhances occupant safety by preventing operation in unsafe conditions. Additionally, the system offers flexibility to vehicle manufacturers, allowing them to select the specific safety features to be monitored based on their requirements and regulatory needs.

Another key advantage of this system is its ability to differentiate between approved helmets and other types of headgear, such as hats, bicycle helmets, or non-compliant protective equipment. By leveraging advanced deep learning algorithms, the system can accurately identify whether a rider or passenger is wearing an industry-approved helmet that meets safety standards, reducing the risk of improper protection due to incorrect or inadequate headgear.

Another yet advantage of the invention is that the system first determines whether a seat is occupied before checking for compliance with safety requirements. This capability allows seamless integration with existing safety mechanisms, such as seat belt buckle switches, without the need for additional hardware like pressure sensors in vehicle seats. Instead of relying on costly seat sensors to activate safety checks, the system visually identifies the presence of an occupant and subsequently verifies whether the seat belt buckle switch is engaged. This not only enhances the efficiency and reliability of safety monitoring but also provides a cost-effective solution for vehicle manufacturers by eliminating the need for extra sensor components.

A key functional advantage of the system is its direct integration with the vehicle's safety architecture, enabling active intervention rather than merely issuing driver alerts or passive feedback. Depending on the vehicle's configuration, the system can enforce safety compliance by either dynamically restricting speed until all mandatory safety equipment is properly used or even completely disabling vehicle operation. This ensures that safety enforcement is not solely dependent on user compliance but is actively controlled through the vehicle's operational parameters.

A further yet advantage is the system's long-term adaptability and continuous improvement through seamless software updates. New or improved neural network (NN) models can be deployed to accommodate evolving helmet designs and safety gear by utilizing existing “over-the-air” (OTA) update frameworks commonly found in modern vehicles. Alternatively, updates can be installed via firmware flashing at authorized dealerships or service centers, ensuring compatibility with emerging safety standards and maintaining system effectiveness over time.

To further optimize performance while maintaining cost efficiency, the system employs highly compact neural networks that achieve high accuracy with minimal computational overhead. This design choice allows vehicle manufacturers to integrate the system without significantly increasing hardware costs, ensuring affordability while still delivering robust safety compliance monitoring. By prioritizing efficiency in neural network architecture, the system remains scalable across various vehicle types without requiring expensive high-performance computing hardware.

It is contemplated that any embodiment discussed in this specification can be implemented with respect to any method of the invention, and vice versa. It will be also understood that particular embodiments described herein are shown by way of illustration and not as limitations of the invention. The principal features of this invention can be employed in various embodiments without departing from the scope of the invention. Those skilled in the art will recognize, or be able to ascertain using no more than routine experimentation, numerous equivalents to the specific procedures described herein. Such equivalents are considered to be within the scope of this invention and are covered by the claims.

All publications and patent applications mentioned in the specification are indicative of the level of skill of those skilled in the art to which this invention pertains. All publications and patent applications are herein incorporated by reference to the same extent as if each individual publication or patent application was specifically and individually indicated to be incorporated by reference. Incorporation by reference is limited such that no subject matter is incorporated that is contrary to the explicit disclosure herein, no claims included in the documents are incorporated by reference herein, and any definitions provided in the documents are not incorporated by reference herein unless expressly included herein.

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps. In embodiments of any of the compositions and methods provided herein, “comprising” may be replaced with “consisting essentially of” or “consisting of”. As used herein, the phrase “consisting essentially of” requires the specified integer(s) or steps as well as those that do not materially affect the character or function of the claimed invention. As used herein, the term “consisting” is used to indicate the presence of the recited integer (e.g., a feature, an element, a characteristic, a property, a method/process step or a limitation) or group of integers (e.g., feature(s), element(s), characteristic(s), propertie(s), method/process steps or limitation(s)) only.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AB, BBC, AAABCCCC, CBBAAA, CABABB, and so forth. The skilled artisan will understand that typically there is no limit on the number of items or terms in any combination, unless otherwise apparent from the context.

As used herein, words of approximation such as, without limitation, “about”, “substantial” or “substantially” refers to a condition that when so modified is understood to not necessarily be absolute or perfect but would be considered close enough to those of ordinary skill in the art to warrant designating the condition as being present. The extent to which the description may vary will depend on how great a change can be instituted and still have one of ordinary skilled in the art recognize the modified feature as still having the required characteristics and capabilities of the unmodified feature. In general, but subject to the preceding discussion, a numerical value herein that is modified by a word of approximation such as “about” may vary from the stated value by at least ±1, 2, 3, 4, 5, 6, 7, 10, 12, 15, 20 or 25%.

All of the devices and/or methods disclosed and claimed herein can be made and executed without undue experimentation in light of the present disclosure. While the devices and methods of this invention have been described in terms of preferred embodiments, it will be apparent to those of skill in the art that variations may be applied to the devices and/or methods and in the steps or in the sequence of steps of the method described herein without departing from the concept, spirit and scope of the invention. All such similar substitutes and modifications apparent to those skilled in the art are deemed to be within the spirit, scope and concept of the invention as defined by the appended claims.

What is claimed is:

1. A vehicle occupant safety detection system comprising or having access to a camera with a field of view configured to observe at least one vehicle occupant, wherein the vehicle occupant safety detection system further comprising a helmet determination sub-system, in turn, comprising a helmet recognition neural network block previously trained using a labeled database of images showing proper use and improper use/lack of use of an approved helmet, and a helmet monitoring block configured to operate the helmet recognition neural network to process an image from the camera to detect a presence of an approved helmet, if any, on the at least one vehicle occupant.

2. The vehicle occupant safety detection system, as in claim 1, further configured to produce a binary “safe” or “unsafe” determination and transmit thereof to a Vehicle Safety System.

3. The vehicle occupant safety detection system, as in claim 1, further configured to detect a presence of an approved helmet, if any, on multiple vehicle occupants by (i) dividing the image from the camera into individual sub-images each containing a single vehicle occupant and analyzing each individual sub-image to detect the presence of an approved helmet on the corresponding vehicle occupant, or (ii) by analyzing the image after being pretrained to recognize a presence of multiple vehicle occupants and detecting the presence of an approved helmet on each corresponding vehicle occupant.

4. The vehicle occupant safety detection system, as in claim 1, wherein approved helmets comprise an approved half helmet, an approved full face helmet, or an approved motocross helmet.

5. The vehicle occupant safety detection system as in claim 1, further comprising an eye protection detection sub-system, in turn, comprising an eye protection recognition neural network block previously trained using a labeled database of images showing proper use and improper use/lack of use of an approved eye protection device, and an eye protection monitoring block configured to process the image from the camera to operate the eye protection recognition neural network to detect a presence of an approved eye protection device, if any, on the at least one vehicle occupant.

6. The vehicle occupant safety detection system as in claim 5, further comprising a safety restraint detection sub-system, in turn, comprising a safety restraint recognition neural network block previously trained using a labeled database of images showing proper use and improper use/lack of use of an approved safety restraint device, and a safety restraint monitoring block configured to operate the safety restraint recognition neural network to process the image from the camera to detect a presence of an approved safety device, if any, on the at least one vehicle occupant.

7. The vehicle occupant safety detection system, as in claim 6, wherein approved safety restraint devices comprise an approved safety belt and an approved safety harness.

8. A vehicle occupant safety detection system comprising or having access to a camera with a field of view configured to observe at least one vehicle occupant to detect either a proper use or an improper use/lack of use of all mandatory safety devices, wherein the vehicle occupant safety detection system further comprising at least one of:
a. a helmet determination sub-system, in turn, comprising a helmet recognition neural network block previously trained using a labeled database of images showing proper use and improper use/lack of use of an approved helmet, and a helmet monitoring block configured to operate the helmet recognition neural network to process an image from the camera to detect a presence of an approved helmet, if any, on the at least one vehicle occupant,
b. an eye protection detection sub-system, in turn, comprising an eye protection recognition neural network block previously trained using a labeled database of images showing proper use and improper use/lack of use of an approved eye protection device, and an eye protection monitoring block configured to process the image from the camera to operate the eye protection recognition neural network to detect a presence of an approved eye protection device, if any, on the at least one vehicle occupant, and
c. a safety restraint detection sub-system, in turn, comprising a safety restraint recognition neural network block previously trained using a labeled database of images showing proper use and improper use/lack of use of an approved safety restraint device, and a safety restraint monitoring block configured to operate the safety restraint recognition neural network to process the image from the camera to detect a presence of an approved safety device, if any, on the at least one vehicle occupant,
wherein the vehicle occupant safety detection system is further configured to automatically process the at least one image of at least one vehicle occupant to determine vehicle operation as “safe” in case the vehicle occupant properly uses all mandatory safety devices or as “unsafe” in case the vehicle occupant is present in the vehicle and does not use at least one mandatory safety device.

9. The vehicle occupant safety detection system, as in claim 8, further comprising a connection to a Vehicle Safety System, wherein, upon making an “unsafe” determination, the vehicle occupant safety detection system is configured to automatically cause the Vehicle Safety System to restrict vehicle operation.

10. The vehicle occupant safety detection system, as in claim 8, further configured to detect a presence of an approved mandatory safety device, if any, on multiple vehicle occupants by dividing the image from the camera into individual sub-images, wherein each individual sub-image contains a single vehicle occupant, and analyzing each individual sub-image to detect the presence of at least one mandatory safety device on the corresponding vehicle occupant.

11. The vehicle occupant safety detection system, as in claim 10, further comprising a connection to a Vehicle Safety System, wherein, upon making an “unsafe” determination based on at least one vehicle occupant not wearing or improperly wearing at least one mandatory safety device, the vehicle occupant safety detection system is configured to automatically cause the Vehicle Safety System to restrict vehicle operation.

12. A vehicle occupant safety detection system comprising or having access to a camera with a field of view configured to observe at least one vehicle occupant to detect either a proper use or an improper use/lack of use of all mandatory safety devices,
wherein the vehicle occupant safety detection system further comprising a safety detection module configured to detect a presence and proper use of all approved and mandated safety devices by all present vehicle occupants using an image from the camera,
wherein the safety detection module operates a neural network and a computer model pretrained using a labeled database of images showing proper use and improper use/lack of use of at least one or more approved safety devices as mandated for the vehicle, and
wherein the vehicle occupant safety detection system is further configured to automatically process the at least one image of at least one vehicle occupant to determine vehicle operation as “safe” in case the vehicle occupant properly uses all mandatory safety devices or as “unsafe” in case the vehicle occupant is present in the vehicle and does not use at least one mandatory safety device.

13. The vehicle occupant safety detection system, as in claim 12, wherein the safety device is one of a helmet, an eye protection, or a safety restraint.
